(19) United States
(12) Patent Application Publication
(10) Pub. No.: US 2020/0095139 A1
(43) Pub. Date: Mar. 26, 2020

(54) Method for Controlling an Electro-Oxidation Process Using Boron Doped Diamond Electrodes

(71) Applicant: HLC Wastewater Technology, Inc., Carnegie, PA (US)

(72) Inventors: Joseph P. Myers, Carnegie, PA (US); Yanbo Li, Beijing (CN); Andrew R. Macdonald-Hardie, McMurray, PA (US)

(21) Appl. No.: 16/574,286

(22) Filed: Sep. 18, 2019

Related U.S. Application Data
(60) Provisional application No. 62/734,481, filed on Sep. 21, 2018.

(51) Int. Cl. C02F 1/467; C02F 1/461

(52) U.S. Cl. CPC C02F 1/4672; C02F 1/46109; C02F 2209/06; C02F 2303/04; C02F 2001/46133

(57) ABSTRACT

The present invention provides a method of controlling pH of wastewater being treated by electro-oxidation in an electrochemical cell containing boron doped diamond electrodes. The method comprises allowing and adjusting pH of electrolytes to vary within a defined pH range about a target pH setpoint at a required rate, wherein the pH setpoint, the defined pH range and rate of pH variation is optimized to maximize rate of pollutant destruction in the wastewater.

The present application claims priority to U.S. Provisional Application No. 62,734,481, filed Sep. 21, 2018, which is incorporated herein by reference in its entirety.

### TECHNICAL FIELD

This invention relates to a method for the treatment of wastewaters using electro-oxidation on boron doped diamond electrodes which achieves almost total destruction of undesirable solutes or pollutants in the wastewaters at high rates of reaction.

### BACKGROUND

The safe disposal of polluted wastewaters is a perennial problem for the world's industries. Many different processes have been developed and utilized to treat wastewaters so that they can meet safe discharge limits. One such process is electro-oxidation utilizing boron doped diamond (BDD) electrodes. Over the past several decades considerable effort has been expended by workers in various countries to develop the process to treat industrial wastewaters. Most of this work has been in the laboratory and on pilot systems and to date there has been limited success in commercializing the process. The technology has been proven to be capable of firstly almost completely destroying all organic species, and some inorganic species in industrial wastewaters, and secondly doing so at a rate approximately corresponding to 100% current efficiency derived according to Faraday's Law. No other electrode material when employed in an electro-oxidation process has proved capable of achieving this performance.

The cost of the boron doped diamond electrode material has proven to be a barrier to developing commercial systems and although the process can treat industrial wastewaters to almost totally remove a broad spectrum of pollutants the rate of the reactions that occur has still proven too slow. As a consequence of the slow reaction rates, a large electrode area is required which has resulted in the capital cost of electro-oxidation systems using boron doped diamond electrodes being high such that their use to treat the majority of industrial wastewater has proven to be not economically feasible. There are really only two routes to achieving economic sustainability and hence providing a route to the commercial use of the technology and these are i) reduce the cost of the boron doped diamond electrode, and ii) significantly increase the rate of reaction. Much effort has been put into i) using approaches utilizing thin diamond films, diamond particles held in a matrix, and others with little success. There has been even less success with respect to ii) mainly because most practitioners of the art have accepted that rates of reaction significantly greater than that signified by 100% current efficiency cannot be achieved. Schemes which have incorporated the injection of oxygen or ozone have been considered but the increase in rate of reaction has not been enough to overcome the high cost of the BDD electrodes. One of the considerable attractions of using an electro-oxidation process to destroy pollutants in wastewaters is that it is perceived to be a simple process. The process is considered to be chemical free and just entails passing a current through the electrolyte, the wastewater, and the electrode material will cause the desired reactions to occur and oxidize the pollutants. As a consequence, very little attention has been paid by researchers and developers to the identification and proper control of important process parameters.

### SUMMARY OF THE INVENTION

The present invention provides a method of controlling pH of wastewater being treated by electro-oxidation in an electrochemical cell containing boron doped diamond electrodes, comprising allowing and adjusting pH of electrolytes to vary within a defined pH range about a target pH setpoint at a required rate, wherein the pH setpoint, the defined pH range and rate of pH variation is optimized to maximize rate of pollutant destruction in the wastewater.

In an aspect of the invention, the defined pH range is controlled to less than 0.3 pH units, depends upon the nature of the wastewater, and is achieved by cyclically varying the wastewater pH in order to optimize time spent within a pH window so that high rates of reaction are achieved.

### BRIEF DESCRIPTION OF THE FIGURES

In order to enable the reader to attain a more complete appreciation of the invention, and of the novel features and the advantages thereof, attention is directed to the following description when considered in connection with the accompanying drawings, wherein:

FIG. 1 illustrates a generalized process flow diagram for employing the unique wastewater oxidation process in a variety of applications and with a variety of feedwaters; and

FIG. 2 illustrates the way in which the pH of the electrolytes in the wastewater is controlled in this unique process.

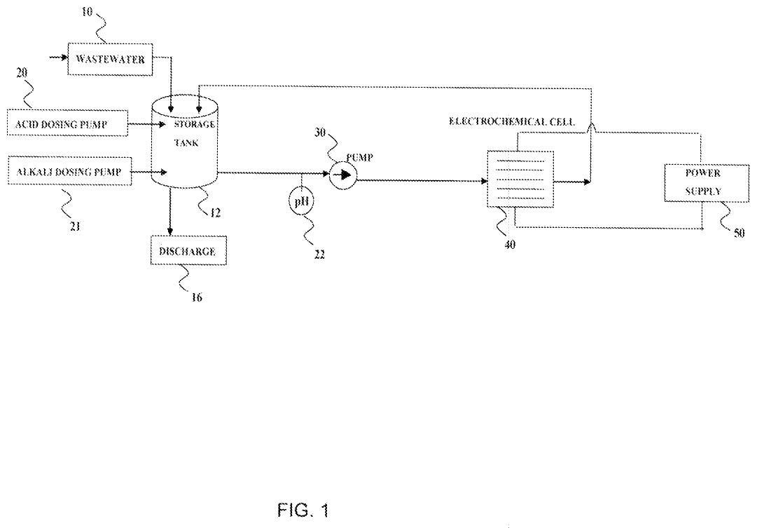

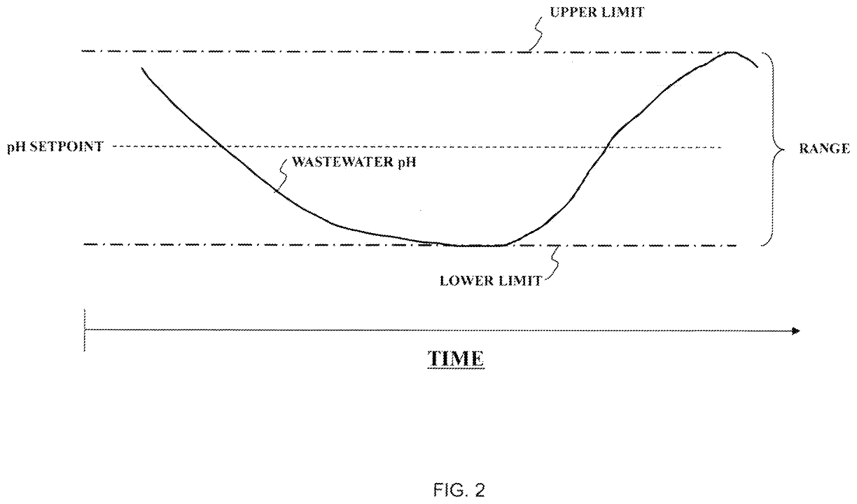

FIGS. 1 and 2, being merely exemplary, contain various process steps or treatment elements that may be present or omitted from actual implementations depending upon the circumstances. An attempt has been made to draw the figures in a way that illustrates at least those elements that are significant for an understanding of the various embodiments and aspects of the invention. However, various other process steps may be utilized in order to provide a complete wastewater treatment system suitable for use in a particular set of circumstances.

### DETAILED DESCRIPTION OF THE INVENTION

The present invention discloses that by controlling certain process parameters with precision and in such a way that practitioners of the art previously have not, then very significant increases in the rate of reaction at the electrodes, and hence the rate at which pollutants are destroyed, can be achieved. From the understanding and knowledge of the inventors of electro-oxidation using a boron doped diamond process, the inventors have identified that the way in which the pH of the wastewater being treated is controlled has a significant effect. Prior to the present invention, the close control of the pH of the electrolytes in the wastewater has not been considered by other workers in the field. During the electro-oxidation process, the pH of the electrolytes changes due to a number of reasons. Normally, in the prior art, the pH is just allowed to drift and to change in an uncontrolled manner. Some practitioners of the art have specified that the electro-oxidation of the wastewaters is performed at acidic or alkali conditions, but other than maintaining these broad requirements, control of pH to particular values has not been attempted. Hitherto, there has not been a realization by practitioners of the art of the need for control to specific values of pH. The present invention discloses that by controlling the pH of the electrolytes in the wastewater, in a particular manner, very high rates of pollutant destruction can be achieved. The achievable rates of destruction are such that the electrode area required can be reduced by greater than an order of magnitude. Such a previously unforeseen reduction in the amount of boron doped diamond electrode material required in an electro-oxidation system results in a large decrease in system capital cost such that it becomes feasible to treat a large variety of wastewaters at a commercially acceptable cost when compared with most other wastewater treatment technologies. Clearly, such a result has not been achieved by any prior art in the field, is unique, and will be of significant benefit.

Referring now to FIGS. 1 and 2, FIG. 1 illustrates a generalized flow schematic of one use of the present invention's novel wastewater oxidation system process in industry. Wastewater 10 containing undesirable pollutants is provided in a storage tank 12. The pH of the tank contents is allowed to vary within a defined band about a setpoint at a required rate. The rate and extent to which the pH varies is regulated if and as required by either dosing an acid using acid dosing pump 20, or dosing an alkali using alkali dosing pump 21. The acid or alkali can be dosed anywhere in the system but normally either into the storage tank itself or the outlet of the storage tank. The wastewater is then routed to the inlet of a pump 30 and then to the inlet of the electrochemical cell 40. Before the wastewater reaches the inlet of the electrochemical cell, the pH is monitored 22 and the resultant reading is used to control the acid dosing pump 20 and the alkali dosing pump 21 in accordance with the scheme shown in FIG. 2. The electrochemical cell 40 contains at least two electrodes manufactured from boron doped diamond (BDD) arranged such that the wastewater can flow between the electrodes and contact both electrodes. A power supply 50 is connected to the electrochemical cell and an electric current is caused to pass through the electrodes and the wastewater. After exiting the electrochemical cell, the partially treated wastewater is returned to the storage tank 12. The wastewater is then re-circulated through the electrochemical cell several times whilst varying and controlling the pH of the wastewater in accordance with the scheme shown in FIG. 2. When the concentration of the pollutants in the wastewater is reduced to the required value the pump and electro-chemical cell are de-energized and the contents of the storage tank are sent to discharge 16.

FIG. 2 is a schematic representation of the way that the pH of the wastewater is controlled and varied during the time that power is applied to the electrochemical cell. It is a characteristic of the electro-oxidation process using BDD electrodes that for the desired rapid reactions to the wastewater to be achieved, specific pH values have to be maintained. This requirement is not recognized and thus not identified in the prior art by other practitioners of electro-oxidation using BDD electrodes; the requirements are unique to the present invention. Operating at the specific pH values which are required is crucial to achieving adequate performance, however, such operation is made difficult due to the achievable accuracy of available pH measurement technology and also because the pH of the wastewater is not stable during the electro-oxidation process. Normal schemes for pH control are not adequate and will more than likely result in operation outside of the required window for the majority, if not all, of the time with the result that rates of reaction are very slow. The scheme shown in FIG. 2 is novel and counter-intuitive in that the objective to operate at the precise values of pH required by varying the pH within a defined range and at an optimized rate are achieved. The scheme facilitates the achievement of the high rates of reaction required in order to make the electro-oxidation process using BDD electrodes economically feasible for the treatment of a large range of wastewaters. The pH of the wastewater is adjusted to approximately a desired setpoint. Once the approximate setpoint has been achieved, power is applied to the electrochemical cell. The pH of the wastewater is then varied in a controlled manner within a defined range by dosing acid and then alkali, or by dosing alkali and then acid. In FIG. 2, initially acid is dosed upstream of the cell inlet in order to progressively depress the pH of the wastewater. Once the lower limit of the defined range has been achieved, the acid dosing is stopped and alkali is dosed in order to increase the pH of the wastewater. Once the upper limit of the defined pH range has been achieved, the alkali dosing is stopped and acid dosing is re-started. This cycle is repeated until the desired results are attained. The size of the range is related to the process performance, and is less than 0.3 pH units.

By means of extensive studies and experiments, the inventors have determined that by controlling the pH in accordance with the scheme shown in FIG. 2, rates of pollutant destruction over five times that heretofore have been considered achievable by other practitioners of the art and even rates as much as fifty times higher can be achieved.

Thus, the critical, unique features of the present invention include, without limitation: (1) the requirement to operate at a specific pH value within a controlled window or range; (2) the required pH value at which the process is operated is dependent upon the nature of the wastewater; (3) operation at the required pH value is achieved by cyclically varying the wastewater pH in order to optimize the time spent within the pH window at which the high rates of reaction are achieved; and (4) by design, it is accepted that the process will not be operating at the required values all of the time, the pH range will be greater than the precise pH window of operation.

### EXAMPLES

The present invention is more particularly described in the following non-limiting example, which is intended to be illustrative only, as numerous modifications and variations therein will be apparent to those skilled in the art.

### Example 1

An oil refinery wastewater was treated at a pH 11.6 setpoint, and the range was 0.25 pH units. The pH was cycled between the upper and lower limits approximately every 15 minutes. Approximately 40% of the organic pollutants in the wastewater were destroyed at a rate between five and ten times that equating to 100% current efficiency before the treatment was terminated.

While the invention has been particularly shown and described with reference to embodiments described above, it will be understood by those skilled in the art that various alterations in form and detail may be made therein without departing from the spirit and scope of the invention, as defined by the appended claims.

What is claimed is:

1. A method of controlling pH of wastewater being treated by electro-oxidation in an electrochemical cell containing boron doped diamond electrodes, comprising allowing and adjusting pH of electrolytes to vary within a defined pH range about a target pH setpoint at a required rate, wherein the pH setpoint, the defined pH range and rate of pH variation is optimized to maximize rate of pollutant destruction in the wastewater.

2. The method of claim 1, wherein the defined pH range is controlled to less than 0.3 pH units.

3. The method of claim 1, wherein the defined pH setpoint at which the method is operated depends upon the nature of the wastewater.

4. The method of claim 1, wherein the defined pH value is achieved by cyclically varying the wastewater pH in order to optimize time spent within a pH window so that high rates of reaction are achieved.
